(19) United States
(12) Patent Application Publication
(10) Pub. No.: US 2019/0342246 A1
(43) Pub. Date: Nov. 7, 2019

(54) NOVEL DECENCY FILTRATION TOOLS AND THEIR USE IN INTERFACING SYSTEMS

(71) Applicants: Thomas P. Theriault, Baldwinsville, NY (US); Mark Dingman, Tully, NY (US)

(72) Inventors: Thomas P. Theriault, Baldwinsville, NY (US); Mark Dingman, Tully, NY (US)

(21) Appl. No.: 16/403,607

(22) Filed: May 5, 2019

Related U.S. Application Data
(60) Provisional application No. 62/667,441, filed on May 5, 2018.

(51) Int. Cl. H04L 12/58; H04L 29/06

(52) U.S. Cl. CPC H04L 51/12; H04L 65/4069; H04L 51/10; H04L 63/08

(57) ABSTRACT

The present invention is directed to novel tools and systems that provide methods to monitor and police platforms for interfacing designed to facilitate the exchange of communications between two or more users. In particular, the present invention provides anonymous and secure methods to capture, monitor, and score users of an interfacing platform, such as a dating platform, based on inappropriate and indecent behavior on the interfacing platform.

### RELATED APPLICATIONS

This application claims priority to U.S. Provisional Patent Application No. 62/667,441 filed on May 5, 2018; the entirety of which is incorporated herein by reference.

### BACKGROUND OF THE INVENTION

In recent years, online dating has grown to be an acceptable means of meeting people. In fact, more people than ever before are choosing to meet online first, rather than undertake a traditional blind date. Such exchange, or interfacing, between these individuals often occurs on a platform that is suitable for communication in the form of both text and video.

Although there is safety in exploring such exchanges via the internet, and “behind a screen” via text exchanges and profile reviews, more and more people are becoming concerned about the security of these types of interactions. In fact, it has become very important to people to make certain that they are comfortable with the individual they are communicating with before meeting in real life.

Even though the technology exists to facilitate peer-to-peer video calling (FaceTime, Skype, etc.), the challenge for dating sites implementing such a feature, is maintaining and enforcing decency standards (appropriate behavior), along with security and privacy. In this respect, many people believe there are significant risks of exchanging personal information and communications with an individual online, and such beliefs reduce the feeling of security and comfort in such interfacing. Moreover, video calling is an even greater concern, where the individual might act with ill intentions, and communicate in an indecent manner. Currently, there are no means to monitor or police this type of behavior that is destructive to the trust a user might place in such a platform.

As such, there is significant need for new tools and systems that provide the ability to monitor and police platforms for interfacing designed to facilitate the exchange of communications between two or more users.

### SUMMARY OF THE INVENTION

Accordingly, the present invention is directed to novel tools and systems that provide methods to monitor and police platforms for interfacing designed to facilitate the exchange of communications between two or more users. In particular, the present invention provides anonymous and secure methods to capture, monitor, and score users of an interfacing platform, such as a dating platform, based on inappropriate and indecent behavior on the interfacing platform.

As such, one aspect of the invention provides a decency filtration tool (DFT) for an interfacing platform designed to facilitate the exchange of communications between two or more users of the interfacing platform, wherein the decency filtration tool comprises a machine-readable medium having instructions stored thereon for execution by a processor to perform a method comprising the steps of: receiving a communication from a sending user into a transient anonymity storage array of an interfacing platform on a second machine-readable medium; presenting the communication to a receiving user with a contextual warning trigger, wherein the execution of the contextual warning trigger affords said receiving user the ability to:
capture transiently stored data from the communication sufficient to afford contextual data support by transferring the communication to the decency filtration tool storage on a third machine-readable medium,
and advancing the decency status level of the sending user, e.g., by one increment; and
terminating access of the sending user to the interfacing platform when the decency status level reaches a preselected level,
   such that any communication received by a receiving user on the interfacing platform may be filtered with the user controlled contextual warning trigger, and the decency status level of each user of the interfacing platform may be tracked and modified to moderate access to the interfacing platform.

Another aspect of the invention provides a decency interfacing system comprising: any decency filtration tool (DFT) of the present invention; and an interfacing platform suitable for exchanging communications between two users and capable of temporarily storing a communication in a transient anonymity storage array on a machine-readable medium.

Yet another aspect of the invention provides a dating platform comprising: any decency filtration tool (DFT) of the present invention; and an interfacing platform suitable for exchanging communications between two users and capable of temporarily storing a communication in a transient anonymity storage array on a machine-readable medium.

### BRIEF DESCRIPTION OF THE FIGURES

Advantages of the present apparatus will be apparent from the following detailed description, which description should be considered in combination with the accompanying figures, which are not intended limit the scope of the invention in any way.

FIG. 1 depicts a schematic representation of certain embodiments of the architecture of the core executed processes of the systems, e.g., interfacing systems, of the present invention.

FIG. 2 depicts a graphic user interface (GUI) of a particular embodiment of the interfacing platforms of the present invention, providing a “Warn Inappropriate” button in the interface for use when video chatting with another user of the interface, initiating capture of the transiently stored data from the communication sufficient to afford contextual data support by transferring the communication to the decency filtration tool storage.

FIG. 3 depicts an administrator graphic user interface (GUI) of a particular embodiment of the interfacing platforms of the present invention, providing a listing of all users whose transiently stored data from a communication has been captured to afford contextual data support by transferring the communication to the decency filtration tool storage.

FIG. 4 depicts a graphic user interface (GUI) of a particular embodiment of the interfacing platforms of the present invention, providing a message in the interface to the user of the interface who has been “warned,” or whose decent status level has reached a preselected level after being warned by the user receiving alleged indecent content; terminating access of the sending user to the interfacing platform.

FIG. 5 depicts a graphic user interface (GUI) of a particular embodiment of the interfacing platforms of the present invention, providing a message to a user of the interface before access to the interface who has been “warned,” or whose decent status level has reached a preselected level after being warned by the user receiving indecent content; terminating access of the sending user to the interfacing platform.

FIG. 6 depicts a graphic user interface (GUI) of a particular embodiment of the interfacing platforms of the present invention, providing a “Report as Inappropriate” selectable menu, in the interface for use when text chatting with another user of the interface, initiating capture of the transiently stored data from the communication sufficient to afford contextual data support by transferring the communication to the decency filtration tool storage.

### DETAILED DESCRIPTION OF THE INVENTION

The present invention facilitates communication between individuals, such as face-to-face video chat, that is both anonymous and secure. The methods, tools, and systems of the present invention provide for transient anonymous storage of the communications, which may be captured and transferred to permanent storage upon a receiving user identifying the communication as indecent or inappropriate through an interface. This function allows the platform to maintain and enforce decency standards (appropriate behavior), as well as security and privacy. Naturally, interfacing systems incorporating the decency filtration tools of the present invention screen out inappropriate and indecent behavior, and increase the feeling of security and comfort in such interfacing, which provide a means to monitor or police this type of behavior that is destructive to the trust a user might place in such a platform.

Accordingly, the present invention is directed to novel tools and systems that provide methods to monitor and police platforms for interfacing designed to facilitate the exchange of communications between two or more users. In particular, the present invention provides anonymous and secure methods to capture, monitor, and score users of an interfacing platform, such as a dating platform, based on inappropriate and indecent behavior on the interfacing platform.

The present invention, including systems, tools, and related methods will be described with reference to the following definitions that, for convenience, are set forth below. Unless otherwise specified, the below terms used herein are defined as follows:

I. Definitions

As used herein, the term “a,” “an,” “the” and similar terms used in the context of the present invention (especially in the context of the claims) are to be construed to cover both the singular and plural unless otherwise indicated herein or clearly contradicted by the context.

The term “filtered” is used herein in reference to a communication, to describe the capture and transfer of the communication from transient storage to more permanent storage (e.g., the decency filtration tool storage) to screen out inappropriate and indecent behavior, e.g., to increase the feeling of security and comfort in interfacing platforms.

The term “indecent” is used herein to describe a relatively objective standard level of behavior, as defined by the administrator of an interfacing platform, beyond which the behavior is considered inappropriate and not suitable for communication between users in the interfacing platform. In certain embodiments, allegations of indecent behavior may be based on a subjective standard level, which is ultimately reviewed and analyzed based on the objective standard level of behavior.

The term “interface” is art-recognized, and is used herein to describe a shared boundary across which two separate components of a computer system exchange information, which can be between software, computer hardware, peripheral devices, humans and combinations of these. In specific embodiments, the term “interface” may be a user interface, e.g., a graphic user interface. Moreover, the operation of two separate components across the boundary, as in the interaction of the user with a user interface, is referred to herein as “interfacing.” In certain embodiments, the interfacing may be bi-directional. In other embodiments, the interfacing may be uni-directional.

The language “machine-readable medium” is art-recognized, and describes a medium capable of storing data in a format readable by a mechanical device (rather than by a human). Examples of machine-readable media include magnetic media such as magnetic disks, cards, tapes, and drums, punched cards and paper tapes, optical disks, barcodes, magnetic ink characters, and solid state devices such as flash-based, SSD, etc. Machine-readable medium of the present invention are non-transitory, and therefore do not include signals per se, i.e., are directed only to hardware storage medium. Common machine-readable technologies include magnetic recording, processing waveforms, and barcodes. In particular embodiments, the machine-readable device is a solid state device. Optical character recognition (OCR) can be used to enable machines to read information available to humans. Any information retrievable by any form of energy can be machine-readable. Moreover, any data stored on a machine-readable medium may be transferred by streaming over a network. In a particular embodiment, the machine-readable medium is a network server disk, e.g., an internet server disk, e.g., a disk array. In specific embodiments, the machine-readable medium is more than one network server disk.

The term “platform” is art-recognized, and is used herein to describe a hardware or software used to host an application or service. An application platform (e.g., interfacing platform) comprises, for example: hardware, an operating system, and coordinating programs that use the instruction set for a particular processor or microprocessor.

The term “storing” is art-recognized, and is used herein to describe the act of saving data on a machine-readable medium in a manner that such data is subsequently retrievable on that machine-readable medium.

The term “transient” is used herein to describe the characteristic of lasting only for a short time, and as such, being impermanent, e.g., transient storage.

The term “transferring” is art-recognized, and is used herein to describe the sharing or transmitting of a file or a logical data object between different users and/or computers both locally and remotely. In certain embodiments, the term “transferring” describes physically moving a file, tagging file for movement, or conversion of file to a different file type.

The term “user” or “operator” are used interchangeably herein to describe any person that operates the systems of the present invention, e.g., interfaces with the user interface of the present invention. In certain embodiments, user is a “sending user,” which is defined with respect to a communication, and is used to describe the sender of that communication (i.e., to the receiving user). In certain embodiments, user is a “receiving user,” which is defined with respect to a communication, and is used to describe the receiver of that communication (i.e., from the sending user).

II. Methods of Facilitating Exchange of Communications of the Invention

One embodiment of the invention provides a method of facilitating the exchange of communications between two or more users of an interfacing platform comprising the steps of:
receiving a communication from a sending user into a transient anonymity storage array of the interfacing platform on a machine-readable medium;
presenting the communication to a receiving user with a contextual warning trigger, wherein the execution of the contextual warning trigger affords said receiving user the ability to:
   capture transiently stored data from the communication sufficient to afford contextual data support by transferring the communication to the decency filtration tool storage on a third machine-readable medium,
   and advancing the decency status level of the sending user, e.g., by one increment; and
terminating access of the sending user to the interfacing platform when the decency status level reaches a preselected level,
   such that any communication received by a receiving user on the interfacing platform may be filtered with the user controlled contextual warning trigger, and the decency status level of each user of the interfacing platform may be tracked and modified to moderate access to the interfacing platform.

In certain embodiments of the methods of the present invention, the communication is a text communication or picture communication.

In certain embodiments of the methods of the present invention, the communication is a video. In certain embodiments, the communication is a live stream video.

A. Receiving a Communication from a Sending User

The methods of the present invention comprise the step of receiving a communication from a sending user into a transient anonymity storage array of the interfacing platform on a machine-readable medium. In particular, a communication sent by a sending user to a receiving user is received into a storage array on the interfacing platform in a transient manner, which serves to temporarily store the communication.

This storage array may be separate from the interfacing platform or may be part of the interfacing platform. The storage array acts to temporarily, or transiently, store the communication data (e.g., on a machine-readable medium) which is deleted after a defined period of time (e.g., after a communication session ends) to maintain anonymous interfacing between the sending user and the receiving user. This anonymity, for example, may serve a privacy and/or security function.

B. Presenting the Communication to Receiving User with Contextual Warning Trigger

The methods of the present invention further comprise the step of presenting the received communication to a receiving user with a contextual warning trigger. The warning trigger is a user selectable mechanism provided with the received communication that affords the receiving user the ability to capture the contextual data from the transient anonymity storage array to support an allegation of indecent behavior presented in the received communication. The contextual warning trigger allows the user to indicate their discontent with the received communication by selecting a user controlled warning trigger. In certain embodiments, the captured data is sent to an administrator for review (e.g., and comparative analysis using a relatively objective standard for indecent behavior). In particular embodiments, the administrator may notify the proper authorities.

In certain embodiments of the methods of the present invention, the contextual warning trigger presented to the receiving user is a selectable user controlled graphic user interface option (e.g., a button, a switch, dropdown selection, or a toggle).

The execution of the contextual warning trigger affords the receiving user the ability to capture transiently stored data from the communication sufficient to afford contextual data support by transferring the communication from the transient anonymity storage array to another machine-readable medium, e.g., the decency filtration tool storage described herein.

In certain embodiments of the methods of the present invention, the captured transiently stored data from the communication is a screenshot of the video stream or a text chat session.

In certain embodiments of the methods of the present invention, the captured transiently stored data from the communication is selected from a full video conference session or a pre-defined period of time sufficient to afford contextual data support.

In certain embodiments of the methods of the present invention, the captured transiently stored data from the communication may also capture contextual data including but not limited to the usernames of both users, the IP address of both users, the device ID for both users, the date and time, or any combination thereof.

i. Decency Status Level

Further, the execution of the contextual warning trigger advances the decency status level of the sending user, e.g., by one increment. The decency status level is the quantitative characterization of the historical behavior of a user, wherein a change from an initial decency status level represents the allegation of an indecent behavior of the user by execution of the contextual warning trigger. In certain embodiments, the decency status level may be adjusted to accommodate multiple tiers of pre-selected decency status levels. In particular embodiments, a decrease in the decency status level represents the allegation of an indecent behavior of the user. In alternative particular embodiments, an increase in the decency status level represents the allegation of an indecent behavior of the user. Moreover, the decency status level of each user of the interfacing platform may be tracked and modified to moderate access to the interfacing platform.

The methods of the present invention further provide for terminating access of the sending user to the interfacing platform when the decency status level reaches a preselected level.

In certain embodiments of the methods of the present invention, the execution of the contextual warning trigger further comprises the step of providing a warning to the sending user.

In certain embodiments of the methods of the present invention, the termination of access of the sending user further comprises the step of providing a second warning to the sending user.

In certain embodiments of the methods of the present invention, the termination of access of the sending user further comprises the step of forwarding the communication to an administrative user.

In certain embodiments of the methods of the present invention, the access to the interfacing system requires authentication that is regulated by the decency status level.

In certain embodiments of the methods of the present invention, the initial decency status level is zero, i.e., assigned a zero value. In particular embodiments, terminating access of the sending user to the interfacing platform occurs when the decency status level reaches 2, e.g., where each execution of the contextual warning trigger advances the initial decency status level by 1.

In certain embodiments of the methods of the present invention, the decency status level may be advanced by more than one increment.

In certain embodiments of the methods of the present invention, the decency status level of a sending user is the aggregate of the execution of a contextual warning trigger by more than one receiving user.

III. Decency Filtration Tools of the Present Invention

The methods of the present invention are useful as instructions stored on a machine-readable medium for execution by a processor to perform the method. In certain embodiments, the methods and tools of the present invention also make use and/or comprise a processor. Accordingly, any methods of the present invention, alone or in combination with other methods (such as those described herein or elsewhere) may be stored on a machine-readable medium for execution by a processor to perform the method. Such a composition comprises a decency filtration tool (DFT) for an interfacing platform designed to facilitate the exchange of communications between two or more users of the interfacing platform.

In this respect, another embodiment of the present invention provides a decency filtration tool (DFT) for an interfacing platform designed to facilitate the exchange of communications between two or more users of the interfacing platform, wherein the decency filtration tool comprises a machine-readable medium having instructions stored thereon for execution by a processor to perform a method comprising the steps of:
receiving a communication from a sending user into a transient anonymity storage array of an interfacing platform on a second machine-readable medium;
presenting the communication to a receiving user with a contextual warning trigger, wherein the execution of the contextual warning trigger affords said receiving user the ability to:
   capture transiently stored data from the communication sufficient to afford contextual data support by transferring the communication to the decency filtration tool storage on a third machine-readable medium,
   and advancing the decency status level of the sending user, e.g., by one increment; and
terminating access of the sending user to the interfacing platform when the decency status level reaches a preselected level,
   such that any communication received by a receiving user on the interfacing platform may be filtered with the user controlled contextual warning trigger, and the decency status level of each user of the interfacing platform may be tracked and modified to moderate access to the interfacing platform.

In certain embodiments of the present invention, the communication is a text communication or picture communication, e.g., through instant messaging.

In certain embodiments of the present invention, the communication is a video. In certain embodiments, the communication is a live stream video.

In certain embodiments of the present invention, the captured transiently stored data from the communication is selected from a full video conference session or a pre-defined period of time sufficient to afford contextual data support, e.g., 15 min (e.g., for reducing server memory use)

In certain embodiments of the present invention, the initial decency status level is zero, e.g., and advances in unit increments. In certain embodiments, terminating access of the sending user to the interfacing platform occurs when the decency status level reaches 2.

In certain embodiments of the present invention, the decency status level may be advanced by more than one increment, e.g., depending on the severity of the indecency, e.g., judged by objective standards.

In certain embodiments of the present invention, the decency status level of a sending user is the aggregate of the execution of a contextual warning trigger by more than one receiving user.

In certain embodiments of the present invention, the contextual warning trigger presented to the receiving user is a selectable user controlled graphic user interface option (e.g., a button, a switch, dropdown selection, or a toggle).

In certain embodiments of the present invention, the execution of the contextual warning trigger further comprises the step of providing a warning to the sending user, e.g., providing a message to the sending user that the sending user has been warned.

In certain embodiments of the present invention, the termination of access of the sending user further comprises the step of providing a second warning to the sending user, e.g., providing a message to the sending user that the sending user has been reported.

In certain embodiments of the present invention, the termination of access of the sending user further comprises the step of forwarding the communication to an administrative user.

In certain embodiments of the present invention, the access to the interfacing system requires authentication that is regulated by the decency status level.

In certain embodiments of the present invention, the machine-readable medium is online software. In a particular embodiment, the software is an online application. In particular embodiments, the software is a web-based application. In an alternative particular embodiment, the software is a cloud-based application. Moreover, the system comprises an interface that may be a web application accessible in an Internet browser, desktop software running on Windows, Mac OS, Linux (or any other operating system), or a mobile application (available on smart devices, e.g., smartphones, or tablets). In particular embodiments, the system interface is a cloud based interface, e.g., based on iOS or Android platforms.

In certain embodiments of present invention, each of the machine-readable media is selected from the group consisting of magnetic media, punched cards, paper tapes, optical disks, barcodes, magnetic ink characters, and solid state devices, e.g., one or more network server disks. In particular embodiments, the machine-readable medium is one or more network server disks.

In certain embodiments of the present invention, the second machine-readable medium and the third machine-readable medium are the same machine-readable medium.

In certain embodiments of present invention, the first machine-readable medium and the third machine-readable medium are the same machine-readable medium.

In certain embodiments of present invention, the first machine-readable medium, second machine-readable medium and the third machine-readable medium are the same machine-readable medium.

IV. Systems of the Present Invention

In certain embodiments of the invention, the decency filtration tool is combined with component devices to form a system or platform, e.g., a dating platform. For example, in particular embodiments, the decency filtration tool is combined with an interfacing platform suitable for exchanging communications between two users and capable of temporarily storing a communication in a transient anonymity storage array on a machine-readable medium. Such systems may be designed to help people connect and maintain relationships, bring together like-minded individuals, offer professional and assistive services e.g., mentoring and coaching, and connect people and places for shared experiences.

A. Interfacing Systems

In this respect, another embodiment of the present invention provides an interfacing system comprising:
a decency filtration tool (DFT) of the present invention; and
an interfacing platform suitable for exchanging communications between two users and capable of temporarily storing a communication in a transient anonymity storage array on a machine-readable medium.

In certain embodiments of the interfacing systems of the present invention, the interface platform is used to facilitate dating (e.g., meeting someone new).

B. Dating Platforms

Another embodiment of the present invention provides a dating platform comprising
a decency filtration tool (DFT) of the present invention; and
an interfacing platform suitable for exchanging communications between two users and capable of temporarily storing a communication in a transient anonymity storage array on a machine-readable medium.

V. Design Aspects of the Invention

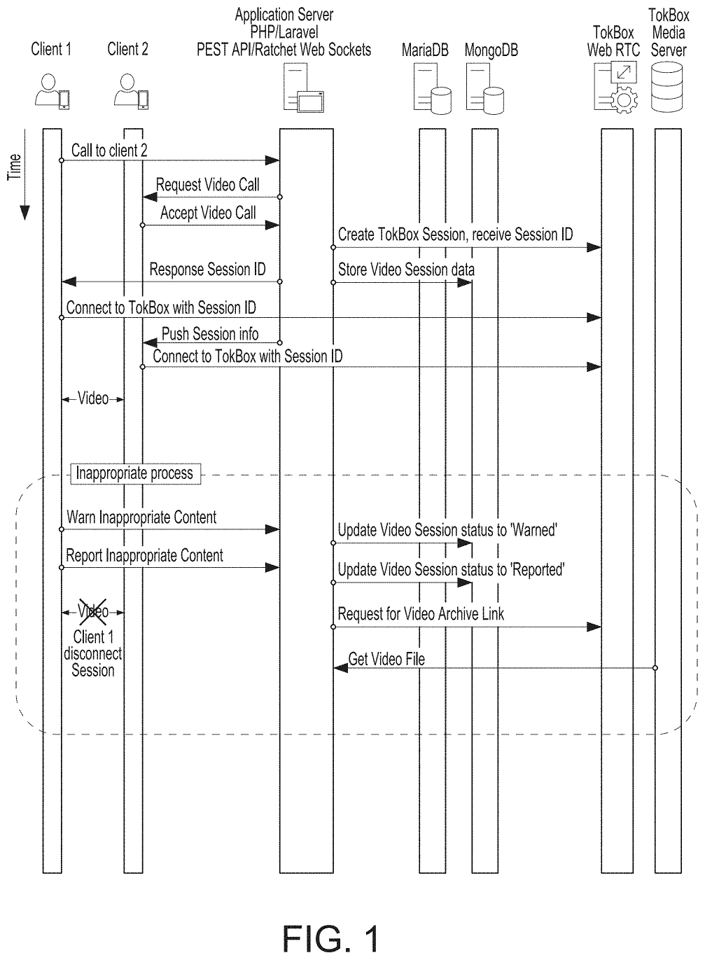

Independent of the utility related to the interfacing systems, dating platforms, and decency filtration tools of the present invention, the ornamental appearance of any novel design provided herein is intended to be part of this invention, for example, each of the views in FIGS. 1 through 6, which may form an independent or combined ornamental appearance of interfacing systems, dating platforms, and decency filtration tools described herein.

Accordingly, one embodiment of the present invention provide an ornamental design for interfacing systems, dating platforms, and decency filtration tools as shown and described.

### EXEMPLIFICATION

Having thus described the invention in general terms, reference will now be made to the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the description provided herein or illustrated in the Figures. The invention is capable of other embodiments and of being practiced and carried out in various ways. Also, it is to be understood that the phraseology and terminology employed herein are for the purpose of description and should not be regarded as limiting.

### Example 1

### Schematic Representation of One Embodiment of an Interfacing System

FIG. 1 depicts a schematic representation of certain embodiments of the architecture of the core executed processes of the interfacing systems of the present invention during video chat/conferencing/call. Client 1 makes a request of Client 2 for a video call, which passes through the interfacing system Application Server and then passes the request to Client 2. Both Client 1 and Client 2 are routed to a video hosting server, TokBox Web RTC to engage in a video call. The video session is transiently stored on video hosting server server/database, i.e., the transient anonymity storage array of an interfacing platform.

If one of Client 1 or Client 2 indicates the video conference/call is inappropriate/indecent (Client 1 as shown) by executing the contextual warning trigger, then the transiently stored video session is captured from the TokBox Web RTC and stored on the TokBox Media Server with the Application Server interfacing platform serving to coordinate the capture of this contextual data. Moreover, the Client 2 decency status level is updated to reflect being “Warned” and then upon a second time, being ‘Reported.’

### Example 2

### Reporting/Warning in Interfacing System Comprising Decency Filtration Tool

A particular embodiment of the present invention provides an interfacing system comprising a decency filtration tool (DFT) of the present invention, and an interfacing platform suitable for exchanging communications between two users and capable of temporarily storing a communication in a transient anonymity storage array on a machine-readable medium.

In this exemplary embodiment, once the receiving user has determined the content of the communication received from the sending user is objectionable or abusive, the following graphic user interface measures may be presented as contextual warning triggers:
1. Warning (serves as a 1st step—both parties are still able to continue chatting)
2. Report (serves as a 2nd and a final step—both parties are kicked off from the chat, the account of the flagged person will be frozen)

For example, two ways to communicate in the interfacing system are chat messaging and video chatting.

A. Chat Messaging

If one of the participants of conversation (User1) decides that content from User2 is abusive, he (she) is able to “warn” it as inappropriate (1st step). This may be done by clicking on an ‘Actions’ menu (e.g., three dots) on the Conversation screen and selecting ‘Warn Inappropriate’.

Accordingly, User2 receives a message that his (her) conversation is warned. In this embodiment, this serves as a warning, but allows User2 to continue the conversation.

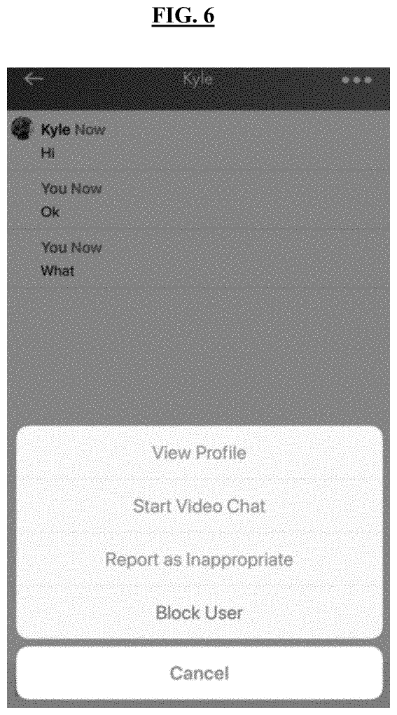

After selecting, the ‘Warn Inappropriate’ button changes its state to ‘Report as Inappropriate’ for User1. In certain embodiments, other users that may chat with User2 will still see it as ‘Warn Inappropriate’. If the content from User2 is still considered as abusive, User1 is able to report it as inappropriate (2nd step); which may be done by clicking on an ‘Actions’ menu (e.g., three dots) on the Conversation screen and selecting ‘Report as Inappropriate’ (see FIG. 6).

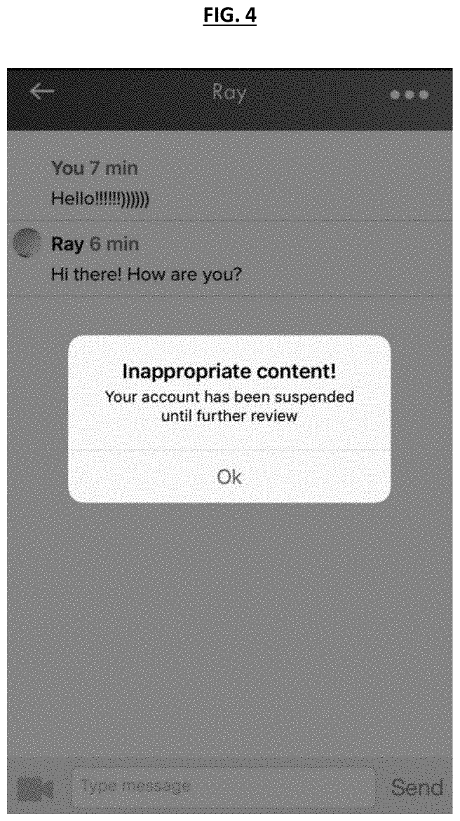

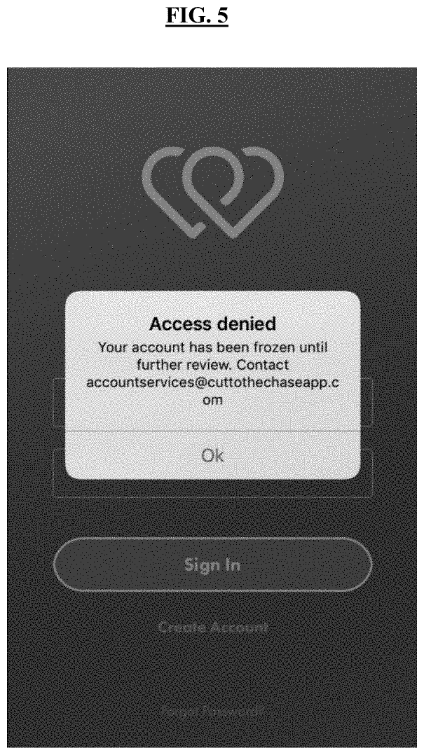

The User who was reported, receives a popup notification that his (her) account has been suspended until further review and his (her) access to the interfacing system is terminated until the further review is complete (see FIG. 4). Moreover, on the attempt to log in again he (she) receives a message that the account has been frozen until further review (see FIG. 5).

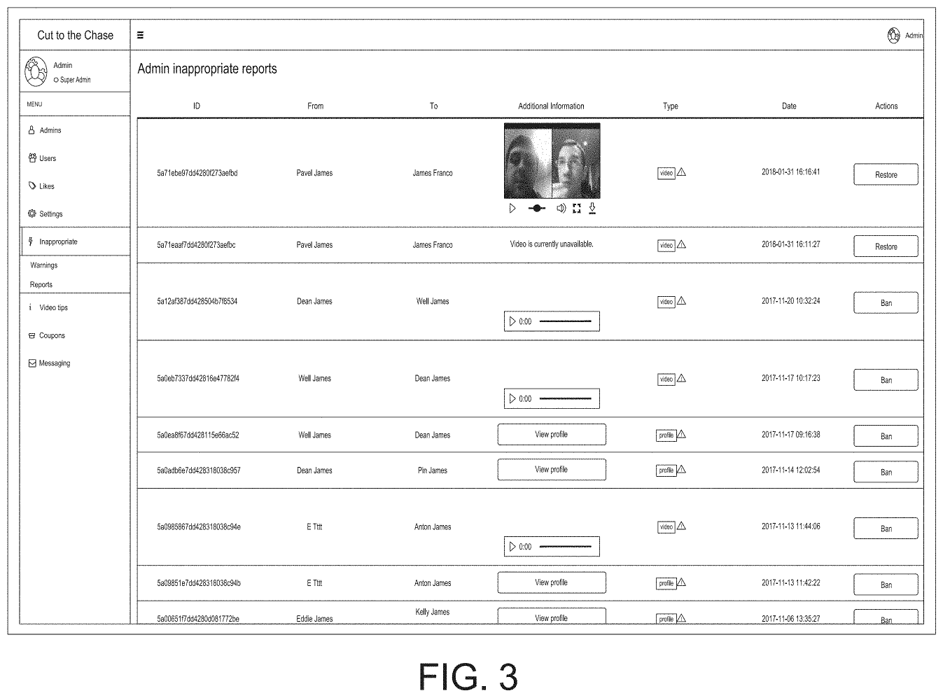

Finally, all the captured data and conversation information goes to an administrator for review, e.g., conversation history, user names and IP addresses, and a time stamp. The administrator is able to restore user's account (see FIG. 3).

B. Video Chat

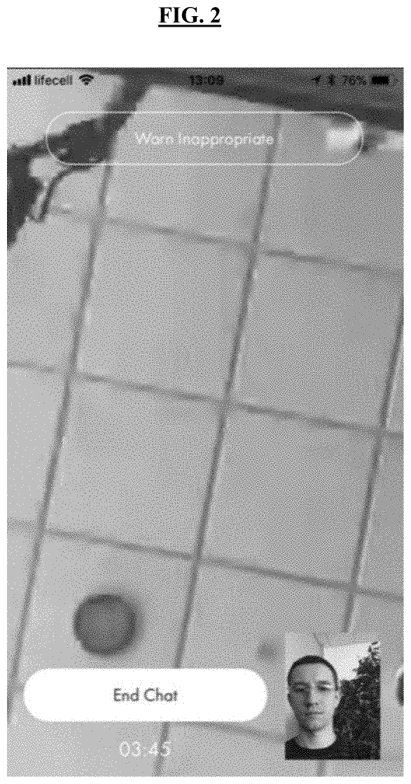

Another option to communicate in the interfacing system is video chat. In this exemplary embodiment, there is ‘Warn Inappropriate’ button on top of the video chat screen (see FIG. 2). Once User1 presses it, the full length video is captured from the transient anonymity storage array of an interfacing platform and is sent to an administrator, e.g., together with both user names, IP addresses, and a time stamp.

User2 then receives a popup that his (she) received a warning. Both users can continue video chatting and button's state is changed to ‘Report as Inappropriate’ for User1. If User1 decides to ‘Report as Inappropriate’, both users are kicked off from the current video chat, the full length video is captured from the transient anonymity storage array of an interfacing platform and is sent to an administrator, e.g., together with both user names, IP addresses, and a time stamp.

User2 who was reported, receives a popup notification that his (her) account has been suspended until further review, and his (her) access to the interfacing system is immediately terminated until the further review is complete. On the attempt to login he (she) receives a popup notification that the account has been frozen until further review.

The administrator is able to restore user's account (see FIG. 3).

C. Emailing Notifications for Warnings and Reports

In both cases A and B described above, when users are warned or reported, they may also receive email notifications. Such emails may, in certain embodiments, comprise the following text bodies:

### **Warning**

“This is your first and final inappropriate behavior warning.

Your profile photo, behavior or language was considered inappropriate or abusive by another person using (the named interfacing system).

You can continue to use the app, but if you are warned again by this person OR someone else, your account will be frozen and placed under review by the application administrators and their legal team.”

### **Reports**

“Your profile photo, behavior or language was considered inappropriate or abusive by a second person using (the named interfacing system) and as such your account is now frozen.

Your account is now under review by the application administrators and our legal team.

We will contact you after our legal team has completed their evaluation and given their recommendation.”

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A decency filtration tool (DFT) for an interfacing platform designed to facilitate the exchange of communications between two or more users of the interfacing platform, wherein the decency filtration tool comprises a machine-readable medium having instructions stored thereon for execution by a processor to perform a method comprising the steps of:
receiving a communication from a sending user into a transient anonymity storage array of an interfacing platform on a second machine-readable medium;
presenting the communication to a receiving user with a contextual warning trigger, wherein the execution of the contextual warning trigger affords said receiving user the ability to:
capture transiently stored data from the communication sufficient to afford contextual data support by transferring the communication to the decency filtration tool storage on a third machine-readable medium,
and advancing the decency status level of the sending user; and
terminating access of the sending user to the interfacing platform when the decency status level reaches a preselected level,
such that any communication received by a receiving user on the interfacing platform may be filtered with the user controlled contextual warning trigger, and the decency status level of each user of the interfacing platform may be tracked and modified to moderate access to the interfacing platform.

2. The decency filtration tool (DFT) of claim 1, wherein the communication is a text communication or picture communication.

3. The decency filtration tool (DFT) of claim 1, wherein the communication is a video.

4. The decency filtration tool (DFT) of claim 3, wherein the communication is a live stream video.

5. The decency filtration tool (DFT) of claim 3, wherein the captured transiently stored data from the communication is selected from a full video conference session or a pre-defined period of time sufficient to afford contextual data support

6. The decency filtration tool (DFT) of claim 1, wherein the initial decency status level is zero.

7. The decency filtration tool (DFT) of claim 6, wherein terminating access of the sending user to the interfacing platform occurs when the decency status level reaches 2.

8. The decency filtration tool (DFT) of claim 1, wherein decency status level may be advanced by more than one increment.

9. The decency filtration tool (DFT) of claim 1, wherein decency status level of a sending user is the aggregate of the execution of a contextual warning trigger by more than one receiving user.

10. The decency filtration tool (DFT) of claim 1, wherein the contextual warning trigger presented to the receiving user is a selectable user controlled graphic user interface option.

11. The decency filtration tool (DFT) of claim 1, wherein execution of the contextual warning trigger further comprises the step of providing a warning to the sending user.

12. The decency filtration tool (DFT) of claim 1, wherein the termination of access of the sending user further comprises the step of providing a second warning to the sending user.

13. The decency filtration tool (DFT) of claim 1, wherein the termination of access of the sending user further comprises the step of forwarding the communication to an administrative user.

14. The decency filtration tool (DFT) of claim 1, wherein the access to the interfacing system requires authentication that is regulated by the decency status level.

15. The decency filtration tool (DFT) of claim 1, wherein each of the machine-readable media is selected from the group consisting of magnetic media, punched cards, paper tapes, optical disks, barcodes, magnetic ink characters, and solid state devices.

16. The decency filtration tool (DFT) of claim 15, wherein the machine-readable medium is one or more network server disks.

17. An interfacing system comprising:
a decency filtration tool (DFT) of claim 1; and
an interfacing platform suitable for exchanging communications between two users and capable of temporarily storing a communication in a transient anonymity storage array on a machine-readable medium.

18. The interfacing system of claim 17, wherein the interface platform is used to facilitate dating.

19. A dating platform comprising:
a decency filtration tool (DFT) of claim 1; and
an interfacing platform suitable for exchanging communications between two users and capable of temporarily storing a communication in a transient anonymity storage array on a machine-readable medium.
